(19) United States
(12) Patent Application Publication
(10) Pub. No.: US 2012/0067919 A1
(43) Pub. Date: Mar. 22, 2012

(54) TAMPER PROOF TOOTHPICK AND MINT DISPENSER

(76) Inventors: Harris Cohen, San Diego, CA (US); Yuval Shenkal, San Diego, CA (US)

(21) Appl. No.: 13/070,356

(22) Filed: Mar. 23, 2011

Related U.S. Application Data
(60) Provisional application No. 61/316,661, filed on Mar. 23, 2010.

(51) Int. Cl. B65D 83/02; E05B 65/52

(52) U.S. Cl. 221/282

(57) ABSTRACT

Combination toothpick/mint dispensers are rendered tamper proof by incorporating irreversible fasteners for joining the two halves of the housing to one another. Any tampering with the dispenser, for example opening the dispenser to substitute its contents with unauthorized items, necessarily results in an alteration of the appearance of the housing so as to alert the user that the dispenser may have been tampered with.

### CROSS REFERENCES

The application claims the benefit of priority from U.S. Provisional patent application Ser. No. 61/316,661 filed Mar. 23, 2010, the entire contents of which are herein incorporated by reference.

### FIELD OF INVENTION

The invention pertains to a molded plastic dispenser that discharges mints and/or toothpicks, stored within the dispenser, through different discharge apertures, or openings, one at a time.

### BACKGROUND

Combination toothpick/mint dispensers are described in U.S. Pat. No. 7,004,350, incorporated herein by reference. This toothpick/mint dispenser includes two housing halves that are joined or fastened to one another by means of a retaining locks or irreversible fasteners for forming the body of the dispenser. This device either purposefully constructed so as to be reusable, i.e., retaining locks or irreversible fasteners of the two housing halves are separable or releasable for reloading the dispenser with toothpicks and/or mints, or, alternatively, is susceptible to being separated or released without damaging the housing.

What was not recognized in the prior art was that these combination toothpick/mint dispensers are susceptible to tampering, i.e., the housing is susceptible to unauthorized opening and reloading without detection.

What is needed is a tamper proof combination toothpick/mint dispenser.

### SUMMARY OF INVENTION

The invention is directed to improved combination toothpick/mint dispensers wherein the improvement comprises the inclusion of irreversible fasteners for joining the two halves of the housing so as to render the dispenser tamper proof. Irreversible fasteners render a dispenser tamper proof if their unjoining or unfastening necessarily results in an alteration of the appearance of the housing so as to alert the user that the dispenser may have been tampered with. Destruction of the housing would be one type of alteration of appearance that would alert the user that the dispenser has been tampered with. However, other marked alterations of the appearance of the housing can also alert the user that the dispenser has been tampered with. Any tampering with the improved dispenser, for example opening the dispenser so as to substitute its contents with unauthorized items, will necessarily result in the alteration of its appearance so as to alert the user that the dispenser may have been tampered with.

### BRIEF DESCRIPTION OF FIGURES

FIG. 1 is an exploded view of a dispenser having two housing halves, each housing half having unjoined cantilever snaps (sometimes called click locks) for irreversibly locking the two housing halves to one another when joined.

FIG. 2 is an unexploded sectional view of a fragment of the dispenser of FIG. 1 wherein the two housing halved have been joined, illustrating the cantilever snaps in their joined position for rendering the dispenser tamper proof.

FIG. 3 (A, B, and C) illustrates three perspective views of a dispenser being wrapped with irreversible adhesive tape so as to render the dispenser tamper proof. FIG. 3A illustrate the dispenser wherein the irreversible adhesive tape is attached to the bottom half (2) of the dispenser housing but not the top half (1). FIG. 3B is the same as FIG. 3A, except the irreversible adhesive tape is now attached to the top half (1) of the dispenser housing. FIG. 3C is the same as FIG. 3B, except the dispenser is inverted so as to illustrate the irreversible adhesive tape covering the bottom half of the dispenser housing (2).

### DETAILED DESCRIPTION

Combination toothpick/mint dispensers are rendered tamper proof by the incorporation of one or more tamper proof irreversible fasteners. Preferred tamper proof irreversible fasteners include retaining locks, adhesives devices, and welded joining devices. Preferred retaining locks include cantilever snaps or click locks or ball and socket snaps. Preferred adhesives include irreversible adhesive tapes and pin and socket arrangements wherein the pin and socket are glued to one another. Welded joints may be employed at any point of contact between the two housing halves. Preferred points of contact for welded joints include the perimeter of the housing.

### Retaining Locks:

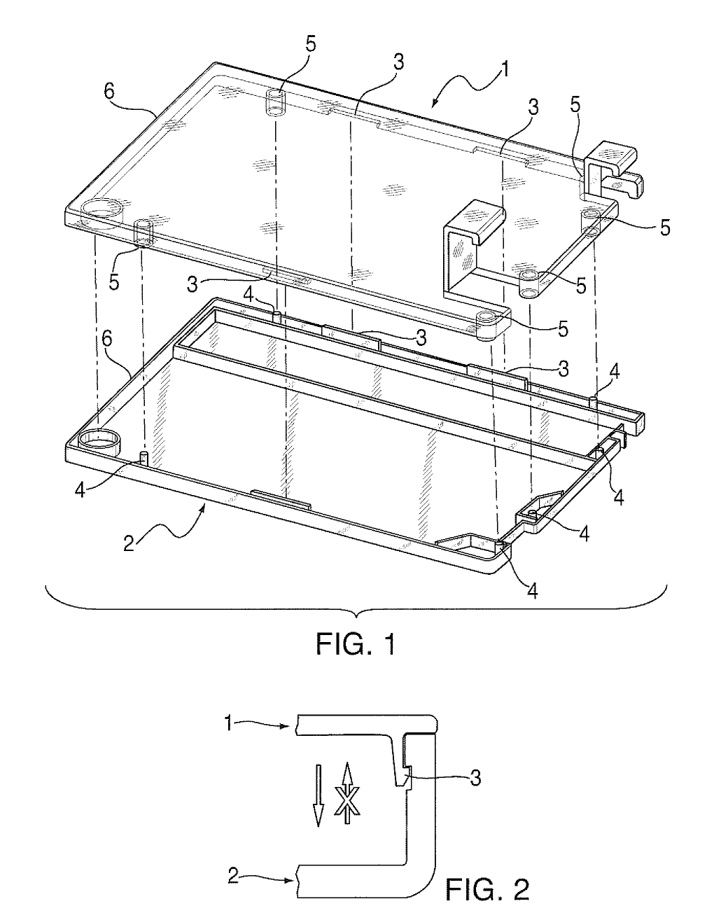

Exemplary tamper proof retaining locks are illustrated in FIGS. 1-2. FIG. 1 illustrates an exploded view of a dispenser having two housing halves (1,2), each housing half incorporating one half of three cantilever snaps (3), viz., one half in the foreground of each of the upper (1) and lower (2) housing halves and two halves in the background of each of the upper (1) and lower (2) housing halves. FIG. 2 illustrates a fragment of a sectional view of the dispenser of FIG. 1 in its unexploded orientation wherein the two housing halves (1,2) are joined to one another. More particularly, FIG. 2 illustrates a cross sectional view of the two halves of the foreground irreversible locking mechanisms of the cantilever snaps (3) joined to one another for joining and locking the two housing halves. When all three cantilever snaps are joined and locked, the two housing halves become irreversibly locked to one another, i.e., they cannot be separated without damaging or altering the housing in such a manner so as to alert the user that the housing has been tampered with.

### Adhesive/Glue

Alternatively or additionally, the dispenser of FIG. 1 may be rendered tamper proof, with or without the cantilever snaps, by gluing the pins (4) and sockets (5) to one another using conventional glue appropriate for their molded plastic composition. When the two housing halves are joined to one another in a tight fit with the pins and sockets glued to one another so as to be irreversibly fastened, the dispenser is rendered tamper proof.

### Sonic Welding

Alternatively or additionally, the dispenser of FIG. 1 may be rendered tamper proof (in its unexploded orientation), with or without the cantilever snaps, by sonically welding the two housing halves at their points of contact, e.g. at points along the perimeter (6) of the two housing halves. Alternatively, the pins (4) and sockets (5) may be welded to one another. When the two housing halves are welded to one another in a tight fit so as to be irreversibly fastened, the dispenser is rendered tamper proof. The weld should be sufficiently strong so that the two housing halves cannot be separated without damaging the housing or altering the appearance of the housing so as to alert the user to that the dispenser has been tampered with.

### Adhesive Tape

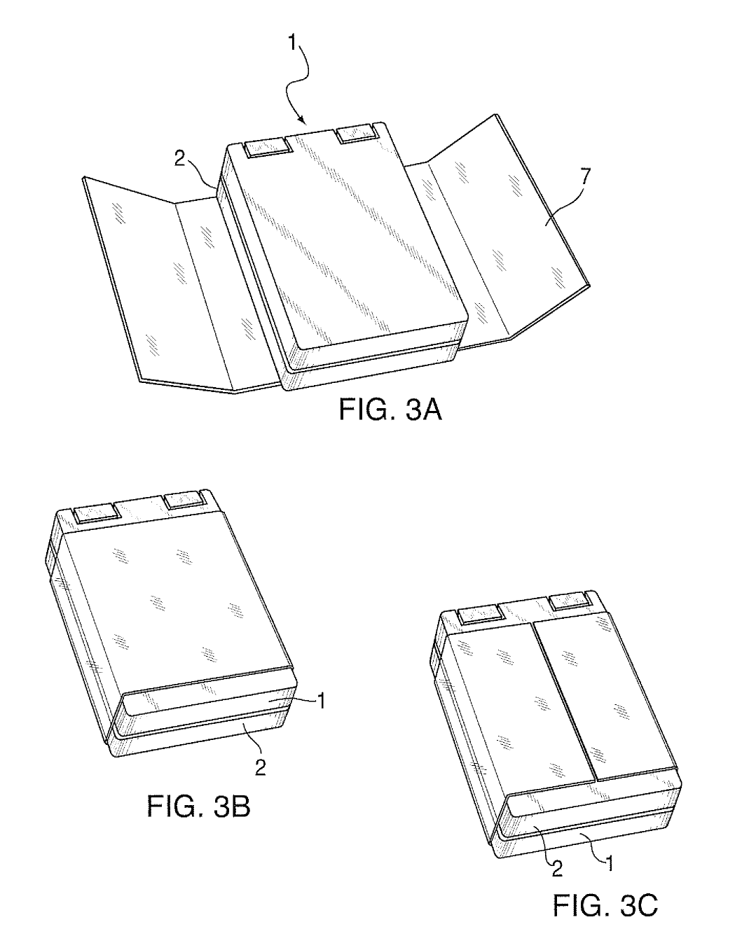

The dispenser of U.S. Pat. No. 7,066,349 may be rendered tamper proof by joining the two housing halves (1,2) with adhesive tape (7), preferably composed of biaxially-oriented polyethylene terephthalate (boPET), e.g., adhesive Mylar™ from 3M™. An exemplary tamper proof dispenser rendered tamper proof with adhesive Mylar™ tape is illustrated in FIG. 3. The adhesive Mylar™ tape is wrapped around the dispenser so as to make the two housing halves inseparable without damaging the housing or altering their appearance so as to alert the user to that the dispenser has been tampered with.

### EXAMPLES

In a preferred embodiment, an improved combination toothpick/mint dispenser has two independent housing halves (1,2), wherein the bottom housing half (2) of the dispenser has a dividing wall that divides the area of the housing half into two separate compartments with one smaller compartment for holding toothpicks and the other larger compartment for holding mints.

In an alternative embodiment, an improved combination toothpick/mint dispenser has two independent housing halves (1,2), wherein the bottom housing half (2) of the dispenser is a single open compartment for holding both toothpicks and mints.

In another embodiment, an improved combination toothpick/mint dispenser has a hinge connecting the two housing halves such that the two housing halves open and close relative to each other by way of the hinge.

In yet another embodiment, an improved combination toothpick/mint dispenser has two independent housing halves such that the top housing half has a tongue-like feature and the bottom housing half has a groove-like feature wherein the tongue-like feature of the top housing half engages the groove-like feature of the bottom housing half to secure the two halves to each other.

1. An improved combination toothpick/mint dispenser having two housing halves, wherein the improvement comprises a tamper proof irreversible fastener for joining the two housing halves in such a manner that unjoining the two housing halves necessarily results either in damage to the housing or alternatively, an alteration of the appearance of the housing so as to alert a user that the dispenser has been tampered with.

2. The improved combination toothpick/mint dispenser of claim 1 wherein the tamper proof retaining lock is a retaining lock.

3. The improved combination toothpick/mint dispenser of claim 2 wherein the retaining lock is a click lock.

4. The improved combination toothpick/mint dispenser of claim 2 wherein the retaining lock is a pin and socket pair wherein the pin and socket are glued to one another.

5. The improved combination toothpick/mint dispenser of claim 2 wherein the retaining lock is a pin and socket pair wherein the pin includes a ball and the socket is adapted for the ball to irreversibly snap into such socket so as to be irreversibly joined thereto.

6. The improved combination toothpick/mint dispenser of claim 2 wherein the retaining lock is a pin and socket pair wherein the pin and socket are sonically welded to one another.

7. The improved combination toothpick/mint dispenser of claim 1 wherein the tamper proof irreversible fastener comprises irreversible adhesive tape for fastening the two housing halves to one another.
